(19) United States
(12) Patent Application Publication
(10) Pub. No.: US 2026/0111332 A1
(43) Pub. Date: Apr. 23, 2026

(54) DYNAMICALLY ENHANCING DATA BACKUP OPERATIONS USING ARTIFICIAL INTELLIGENCE TECHNIQUES

(71) Applicant: Dell Products L.P., Round Rock, TX (US)

(72) Inventors: Zijia Wang, London (GB); Zhen Jia, Shanghai (CN); Ming Zhang, Shanghai (CN)

(21) Appl. No.: 18/920,071

(22) Filed: Oct. 18, 2024

(51) Int. Cl. G06F 11/34

(52) U.S. Cl. CPC G06F 11/3433; G06F 11/3447; G06F 11/3457

(57) ABSTRACT

Methods, apparatus, and processor-readable storage media for dynamically enhancing data backup operations using artificial intelligence techniques are provided herein. An example computer-implemented method includes generating one or more modified sets of one or more time windows for performing at least one data backup operation for a given system by processing, using one or more artificial intelligence techniques, data pertaining to one or more existing sets of one or more time windows for performing the data backup operation(s); predicting future system load information associated with the system by processing one or more system-related metrics using at least one analytics model; dynamically adjusting at least a portion of the modified set(s) of the one or more time windows by processing the predicted future system load information and the modified set(s) of the one or more time windows; and performing one or more automated actions based on the dynamic adjusting.

### BACKGROUND

In the domains of data management and data protection, conventional backup techniques often fail to adapt to the dynamic nature of system loads and operational demands. For example, conventional backup techniques can include fixed and/or static backup windows which do not account for variability in system usage, often resulting in inefficient use of system resources, either by placing undue strain on the system during high-usage periods or by failing to effectively leverage idle periods.

### SUMMARY

Illustrative embodiments of the disclosure provide techniques for dynamically enhancing data backup operations using artificial intelligence techniques.

An exemplary computer-implemented method includes generating one or more modified sets of one or more time windows for performing at least one data backup operation for a given system by processing, using one or more artificial intelligence techniques, data pertaining to one or more existing sets of one or more time windows for performing the at least one data backup operation for the given system. The method also includes predicting future system load information associated with the given system by processing one or more system-related metrics using at least one analytics model, and dynamically adjusting at least a portion of the one or more modified sets of the one or more time windows by processing the predicted future system load information and the one or more modified sets of the one or more time windows. Additionally, the method includes performing one or more automated actions based at least in part on the dynamic adjusting of the at least a portion of the one or more modified sets of the one or more time windows.

Illustrative embodiments can provide significant advantages relative to conventional backup techniques. For example, problems associated with fixed and/or static backup windows which do not account for variability in system usage are overcome in one or more embodiments through dynamically adjusting backup time windows using artificial intelligence techniques and at least one predictive analytics model.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for dynamically enhancing data backup operations using artificial intelligence techniques in an illustrative embodiment.

FIG. 2 is an example architecture and workflow diagram in an illustrative embodiment.

FIG. 3 is a flow diagram of a process for dynamically enhancing data backup operations using artificial intelligence techniques in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

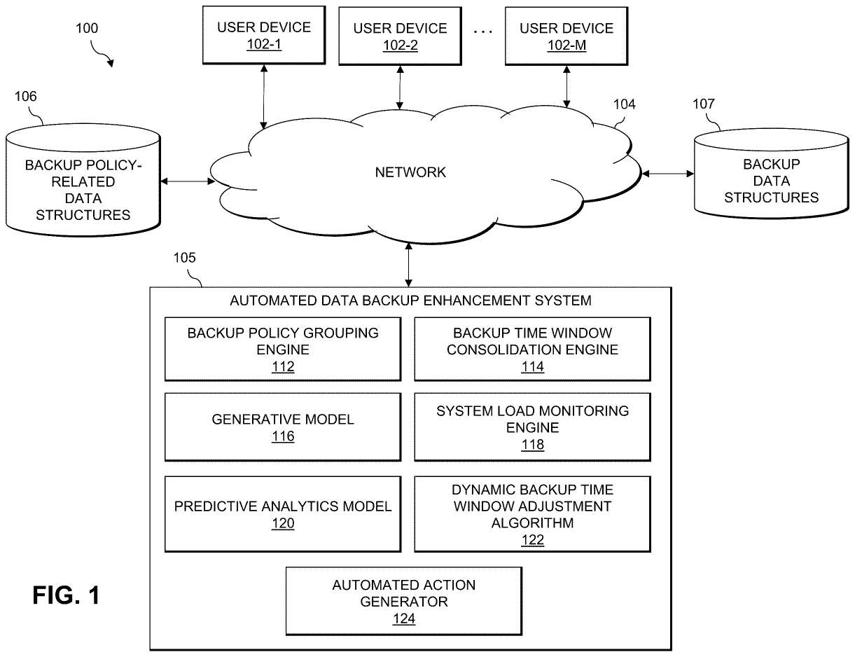

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated data backup enhancement system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated data backup enhancement system 105 can have one or more backup policy-related data structures 106 configured to store data pertaining to backup policy information, backup time window information, system load information, etc. Also, as depicted in FIG. 1, the automated data backup enhancement system 105 can have one or more backup data structures 107 configured to store data pertaining to and/or associated with one or more given systems and serve as a backup source of such data. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The backup policy-related data structures 106 and/or backup data structures 107 in the present embodiment are implemented using one or more storage systems associated with the automated data backup enhancement system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated data backup enhancement system 105 are one or more input-output devices, which illustratively comprise keyboards, displays or other types of input-output devices in any combination. Such input-output devices can be used, for example, to support one or more user interfaces to the automated data backup enhancement system 105, as well as to support communication between the automated data backup enhancement system 105 and other related systems and devices not explicitly shown.

Additionally, the automated data backup enhancement system 105 in the FIG. 1 embodiment is assumed to be implemented using at least one processing device. Each such processing device generally comprises at least one processor and an associated memory, and implements one or more functional modules for controlling certain features of the automated data backup enhancement system 105.

More particularly, the automated data backup enhancement system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated data backup enhancement system 105 to communicate over the network 104 with the user devices 102, and illustratively comprises one or more conventional transceivers.

The automated data backup enhancement system 105 further comprises backup policy grouping engine 112, backup time window consolidation engine 114, generative model 116, system load monitoring engine 118, predictive analytics model 120, dynamic backup time window adjustment algorithm 122, and automated action generator 124.

In one or more embodiments, backup policy grouping engine 112 is responsible for processing and categorizing backup policies based at least in part on their frequency and retention duration parameters. In such an embodiment, backup policies with identical parameters are grouped together as part of the consolidation process. Additionally, backup time window consolidation engine 114 analyzes the grouped backup policies to identify and merge the backup policies with overlapping and/or adjacent backup time windows, forming an initial consolidated schedule.

Also, in at least one embodiment, generative model 116 is implemented to carry out multiple at least one expansion phase and at least one contraction phase. In an expansion phase, which can include adding noise in at least one diffusion model, a generative model is used to determine the expansion possibilities of each policy's backup time window. Generative model 116, in such an embodiment, can be trained to simulate various scenarios wherein backup time windows can be expanded to their maximum possible extent, considering the constraints of adjacent and/or overlapping backup policies. In a contraction phase, which can include reducing noise in at least one diffusion model, a generative model (e.g., a different generative model than the model used in the expansion phase) is used to refine the expanded backup time windows by contracting the windows to optimize at least one corresponding backup schedule. This generative model takes the expanded backup time windows as input and outputs one or more modified backup time windows (e.g., the most efficient backup time windows, per one or more constraints and/or objectives).

In one or more embodiments, system load monitoring engine 118 assesses (e.g., continuously or periodically assesses) system metrics of a given system (e.g., a system operating on one or more of the user devices 102) such as CPU usage, memory consumption, network bandwidth, and disk input-output (I/O), etc. Such real-time data is fed to and/or processed by predictive analytics model 120, which utilizes the system load data to predict one or more future load predictions (e.g., to identify one or more future low-load periods). The predictive analytics model 120 can, in at least one embodiment, employ one or more time series forecasting techniques such as, e.g., at least one autoregressive integrated moving average (ARIMA) model and/or at least one long short-term memory (LSTM) network model, to generate one or more load predictions.

Additionally, dynamic backup time window adjustment algorithm 122 can process, as input, current system load data, predicted future system load data, and one or more backup time windows determined during the contraction phase by generative model 116. The dynamic backup time window adjustment algorithm 122 processes such inputs to evaluate if the current and/or predicted system load(s) will conflict with one or more scheduled backups. If yes (i.e., the current and/or predicted system load(s) will conflict with one or more scheduled backups), dynamic backup time window adjustment algorithm 122 can determine and output adjustments to the one or more relevant backup time windows to align with one or more predicted low-load periods.

Further, automated action generator 124 can automatically initiate and/or perform one or more functions such as, e.g., executing one or more data backup operations in accordance with the one or more adjusted backup time windows (e.g., backing up data in backup data structures 107 during the one or more adjusted backup time windows).

It is to be appreciated that this particular arrangement of elements 112, 114, 116, 118, 120, 122 and 124 illustrated in the automated data backup enhancement system 105 of the FIG. 1 embodiment is presented by way of example only, and alternative arrangements can be used in other embodiments. For example, the functionality associated with elements 112, 114, 116, 118, 120, 122 and 124 in other embodiments can be combined into a single module, or separated across a larger number of modules. As another example, multiple distinct processors can be used to implement different ones of elements 112, 114, 116, 118, 120, 122 and 124 or portions thereof.

At least portions of elements 112, 114, 116, 118, 120, 122 and 124 may be implemented at least in part in the form of software that is stored in memory and executed by a processor.

It is to be understood that the particular set of elements shown in FIG. 1 for dynamically enhancing data backup operations using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated data backup enhancement system 105, backup policy-related data structures 106, and backup data structures 107 can be on and/or part of the same processing platform.

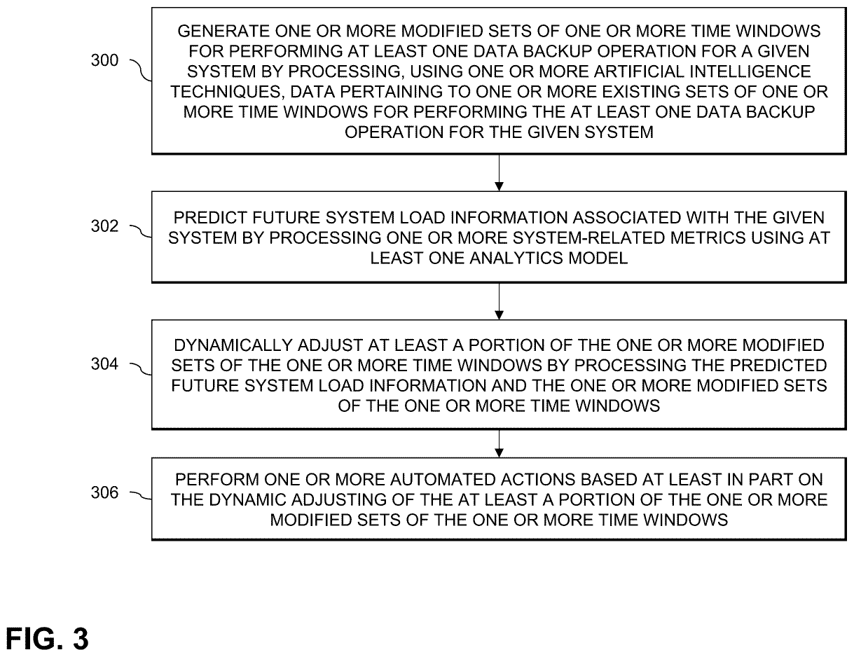

An exemplary process utilizing elements 112, 114, 116, 118, 120, 122 and 124 of an example automated data backup enhancement system 105 in computer network 100 will be described in more detail with reference to the flow diagram of FIG. 3.

Accordingly, at least one embodiment includes dynamic data backup enhancement using one or more generative diffusion models. Such an embodiment can include implementing a multi-phase process utilizing one or more generative diffusion models for the dynamic consolidation of backup policies.

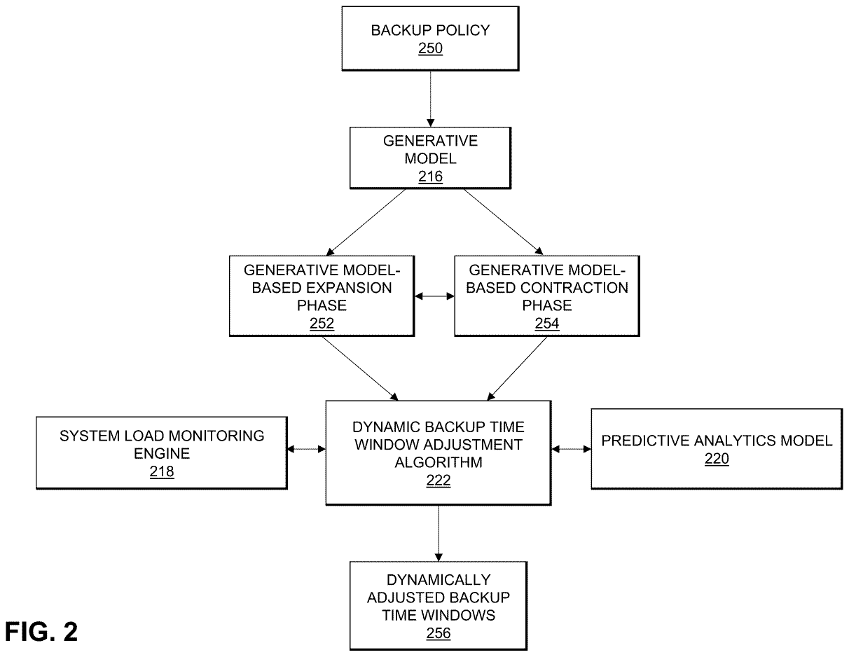

FIG. 2 is an example architecture and workflow diagram in an illustrative embodiment. By way of illustration, FIG. 2 depicts generative model 216, which processes backup policy 250 and initiates the above-noted multi-phase process based at least in part on such processing. More particularly, in generative model-based expansion phase 252, generative model 216 determines the expansion of the backup windows of backup policy 250 to one or more extents (e.g., to each its maximum potential extent), considering the constraints of adjacent and/or overlapping policies. This phase allows for the exploration of a range of scheduling possibilities.

Additionally, as depicted in FIG. 2, generative model-based contraction phase 254 uses generative model 216 to refine at least a portion of the backup windows, contracting the backup windows to cover one or more original time slots (e.g., all original time slots) without any loss. Additionally, dynamic backup time window adjustment algorithm 222, informed by real-time data from system load monitoring engine 218 and predictive analytics from predictive analytics model 220, enables the generation and output of dynamically adjusted backup time windows 256, dynamically adjusted to one or more periods of reduced and/or minimal system load, enhancing system performance and resource efficiency.

Accordingly, at least one embodiment includes applying one or more generative diffusion models to backup policy management, employing such models in the expansion and contraction of backup windows to dynamically enhance and/or optimize backup scheduling. Additionally, such an embodiment can include leveraging one or more specialized loss functions during the training of one or more generative models to ensure that the generated backup policies comprehensively cover necessary time windows while reducing and/or minimizing the total number of policies, balancing coverage and efficiency. Further, one or more embodiments include implementing a dynamic policy adjustment mechanism that leverages real-time system load monitoring coupled with predictive analytics, enabling real-time adjustments of backup schedules based at least in part on current and predicted system loads, enhancing resource utilization. As such, at least one embodiment includes generating and/or implementing an adaptive system capable of optimizing backup schedules in real-time, according to changing system loads and/or operational demands.

As detailed herein (e.g., in connection with FIG. 1) one or more embodiments include implementing at least one generative model (e.g., one or more generative diffusion models) to carry out at least one expansion phase and at least one contraction phase with respect to a give system. In an expansion phase, at least one generative model is used to explore the expansion of each backup policy's backup time window. The at least one generative model generates a range of expanded backup time windows, exploring possible backup schedules that can potentially accommodate more flexible backup operations and/or better resource utilization. The at least one generative model is trained on historical data to simulate various scenarios, generating a range of expanded backup time windows. The window expansion process can be represented in Equation (1) as follows:

$${W}_{e x p a n d e d} = {W}_{o r iginal} ⊕ Δ W \qquad ( 1 )$$

wherein W_{expanded} is an expanded backup time window, W_{original} is the original backup time window, ⊕ is a direct sum operation, and ΔW is the potential expansion based on the generative model's simulation.

In a contraction phase, at least one generative model refines one or more of the expanded backup time windows by contracting such backup time windows to enhance and/or optimize the overall backup schedule for the given system. The at least one generative model takes the expanded backup time windows (determined in the expansion phase) as input and outputs one or more modified backup time windows (e.g., the most efficient backup window(s)). The backup time window contraction process can be represented in Equation (2) as follows:

$${W}_{contracted} = min ( {W}_{e x p a n d e d} ⊖ Δ {W}^{′} ) \qquad ( 2 )$$

wherein W_{contracted} is the contracted backup time window, W_{expanded} is the input expanded backup time window, ⊖ is a symmetric difference operation, and ΔW′ is the contraction adjustment made by the at least one generative model.

As also detailed herein, one or more embodiments include implementing dynamic backup policy adjustments in conjunction with predictive analytics. Such an embodiment includes leveraging real-time system load data (e.g., using system load monitoring engine 118) and at least one predictive analytics model (e.g., predictive analytics model 120) to dynamically adjust one or more backup time windows (e.g., using dynamic backup time window adjustment algorithm 122) generated by the at least one generative model. Such an embodiment aims to enhance and/or optimize backup schedules for the given system based at least in part on current and anticipated system loads, thereby reducing and/or minimizing resource contention and executing at least a portion of the data backup operations during periods of low system activity.

An example dynamic time window adjustment algorithm can be represented in Equation (3) as follows:

$${W}_{adjusted} = {W}_{contracted} \pm Δ {T}_{adjustment} \qquad ( 3 )$$

wherein W_{adjusted} represents the dynamically adjusted backup time window, W_{contracted} represents the contracted backup time window determined by the at least one generative model during the contraction phase, and ΔT_{adjustment} represents the time adjustment based at least in part on real-time and predicted system load data.

In one or more embodiments, calculating the ΔT_{adjustment} includes considering a time adjustment applied to optimized backup time windows to align the backup time windows with periods of lower system load, based on real-time monitoring and predictive analytics. This adjustment can ensure, for example, that data backup operations do not interfere with peak system activities, optimizing resource utilization and minimizing potential disruptions. The calculation of ΔT_{adjustment} can involve factors including, e.g., the severity of the predicted load, the duration of the backup time window, and the availability of low-load periods. Additionally, ΔT_{adjustment} can be determined by analyzing the difference between the current or predicted system load and the thresholds set for one or more data backup operations.

More particularly, predicted load severity (L_{predicted}) quantifies the expected system load during the original backup time window, and such a value is derived from the predictive analytics model and is a measure of resource usage intensity. Also, load threshold (L_{threshold}) represents a predefined threshold indicating the maximum acceptable system load during data backup operations. If L_{predicted} exceeds L_{threshold}, an adjustment is necessary. Additionally, available low-load window (W_{low-load}) represents the next available time window wherein L_{predicted}<L_{threshold}, indicating a suitable period for data backup operations with minimal impact on system performance.

With respect to determining an adjustment calculation, if L_{predicted}≥L_{threshold} for an original backup time window, at least one embodiment includes calculating the temporal distance to W_{low-load}, taking into account the duration of the data backup operation and ensuring that the adjusted window does not overlap with one or more other critical system operations. More particularly, calculating a time adjustment can be carried out via Equation (4) as follows:

$$Δ {T}_{a d j u s t m e n t} = {T}_{start , {W}_{low - load}} - {T}_{start , {W}_{c o n t r a c t e d}} \qquad ( 4 )$$

wherein T_{start,W}_{_{low-load}} is the start time of the next low-load time window, and T_{start,W}_{_{contracted}} is the scheduled start time of the contracted backup time window.

In connection with training at least one generative model (e.g., at least one generative diffusion model), one or more embodiments include defining and/or implementing one or more loss functions. The one or more loss functions, which can include, e.g., at least one coverage loss function and at least one efficiency loss function, can guide the training process to ensure that the generated backup policies include all previous policies without any loss of coverage and that the number of policies is minimized to ensure efficiency.

More particularly, a coverage loss function ensures that the generated backup time windows from the expansion phase cover all original time windows specified by the previous backup policies, and verifies that no time slots previously covered are lost in the newly generated policies. In at least one embodiment, calculating the coverage loss includes comparing the union of all original policy windows with the union of the generated policy windows. The loss is minimized when the generated policy windows completely cover the original policy windows. This can be represented mathematically as the difference in coverage between the original and generated backup time windows, wherein a higher difference indicates a higher loss.

Calculating a coverage loss can be defined via Equation (5) as follows:

$${L}_{c o v e r a g e} = \vert O ∖ G \vert \qquad ( 5 )$$

wherein O represents the set of backup time windows covered by the original policies, G represents the set of backup time windows covered by the generated policies, and wherein |0\G| measures the set difference between O and G, quantifying the extent of original coverage not included in the generated policies.

Additionally, in one or more embodiments, calculating |0\G| can include discretizing all windows by converting all original and generated backup time windows into sets of discrete intervals. Such an embodiment can also include creating a union (U_{O}) of all intervals represented by the original policies, wherein this union (U_{O}) represents the total coverage of all original policies. Similarly, such an embodiment can include creating a union (U_{G}) of all intervals represented by the generated policies. Further, such an embodiment can include calculating the set difference between U_{O} and U_{G}, which provides the intervals covered by the original policies that are not covered by the generated policies. The measure |0\G| can then be represented, in such an embodiment by the cardinality (i.e., the number of elements) of the set difference between U_{O} and U_{G}. This number can represent the total amount of time (e.g., in intervals) that was covered by the original policies but is not covered by the generated policies. By discretizing the backup time windows and using one or more efficient data structures, the measure |0\G| can be calculated accurately, providing a foundation for evaluating the coverage loss in the training of the at least one generative model for backup policy consolidation.

An efficiency loss function encourages the reduction and/or minimization of the total number of backup policies generated during the contraction phase, promoting efficiency in data backup scheduling by reducing the complexity and administrative overhead. In at least one embodiment, calculating the efficiency loss is based at least in part on the number of generated policies compared to the number of original policies, with a goal being to minimize this number without sacrificing coverage. The efficiency loss can be defined as a function of the number of generated policies, with penalties for any increase beyond the necessary consolidation.

More particularly, in one or more embodiments, calculating an efficiency loss can be carried out via Equation (6) as follows:

$${L}_{efficiency} = max ( {N}_{g e n e r a t e d} - {N}_{original} , 0 ) \qquad ( 6 )$$

wherein N_{original} represents the number of original policies and N_{generated} represents the number of generated policies after consolidation. The efficiency loss attempts to ensure that the loss is zero or positive, encouraging reduction in the number of policies.

During training, the at least one generative model would aim to minimize a weighted sum of the above-noted loss functions, such as detailed in Equation (7) as follows:

$${L}_{total} = {λ}_{c o v e r a g e} {L}_{coverage} + {λ}_{efficiency} {L}_{efficiency} \qquad ( 7 )$$

wherein λ_{coverage} and λ_{efficiency} are weighting coefficients that balance the importance of each loss according to the specific requirements of the backup policy consolidation task. Also, at least one embodiment can include using gradient descent and/or one or more other optimization algorithms to minimize Lₜₒₜₐₗ during the training of the at least one generative model. Such a process can involve adjusting one or more model parameters to determine a balance between covering one or more required backup time windows and minimizing the number of policies.

Additionally, one or more embodiments can include periodically validating the at least one generative model's performance on unseen and/or new data. Such a validation process can include adjusting one or more of the weighting coefficients (i.e., λ_{coverage} and λ_{efficiency}) as necessary based at least in part on the validation results to achieve a desired balance between coverage and efficiency.

As also detailed herein, for example, in connection with backup policy grouping engine 112 and backup time window consolidation engine 114 in FIG. 1, multiple actions are carried out prior to processing backup policy-related data using at least one generative model. For example, at least one embodiment includes collecting existing backup policies (e.g., from backup policy-related data structures 106) associated with at least one computing environment and conducting a preliminary analysis to prepare at least a portion of the collected backup policies for consolidation. Such an embodiment can include extracting, from the existing backup policies, one or more policy parameters such as, e.g., backup frequency, retention duration, and backup time window information.

More particularly, data collection can include retrieving existing backup policies from a given system's backup management interface or configuration files, wherein each policy is represented as a data structure (e.g., within backup policy-related data structures 106) with attributes for frequency (e.g., daily, weekly, etc.), retention duration (e.g., 7 days, 30 days, etc.), backup time windows (including start times and end times), etc. At least one embodiment can then include normalizing at least a portion of the retrieved data to ensure consistency in units (e.g., converting all times to a 24-hour format) and resolving any format discrepancies.

Subsequent to such normalization, one or more embodiments can include analyzing the existing backup policies to identify policies with one or more similar characteristics (e.g., frequency, retention duration, etc.) that can be consolidated. Such analysis can include performing feature extraction, which can include extracting, from each existing backup policy, one or more features relevant for clustering (such as, e.g., backup frequency, retention duration, etc.) and expressed numerically (e.g., frequency as the number of backups per week, retention duration in days, etc.). Such an embodiment can also include selecting at least one clustering algorithm (e.g., k-means, hierarchical clustering, etc.) based at least in part on one or more dataset characteristics and a desired granularity of policy groupings.

The clustering process can then include normalizing the feature data to ensure a similar scale, and determining the optimal number of clusters (e.g., using the elbow method for k-means) based at least in part on feature variation (e.g., the variation in backup frequencies and retention durations). Accordingly, in an example embodiment, the selected clustering algorithm can be implemented to group existing backup policies with similar backup frequencies and retention durations.

This process can be represented as feature normalization, wherein given a feature xᵢ for policy i, the normalized feature \hat{x}ᵢ is computed via Equation (8) as follows:

$${\hat{x}}_{i} = \frac{{x}_{i} - min ( X )}{max ( X ) - min ( X )} \qquad ( 8 )$$

wherein X represents the set of all values of the feature across policies.

Additionally, in connection with an example embodiment utilizing k-means clustering, such an embodiment aims to minimize the within-cluster sum of squares (WCSS), wherein an objective includes determining a set of centroids C that minimizes such a value via Equation (9) as follows:

$${\sum }_{k = 1}^{K} {\sum }_{{x}_{i} ∈ {S}_{k}} {‖ {x}_{i} - {c}_{k} ‖}^{2} \qquad ( 9 )$$

wherein K represents the number of clusters, Sₖ represents the set of points in cluster k, and cₖ represents the centroid of cluster k.

After the above-noted data collection and analysis, wherein backup policies are clustered based at least in part on similar characteristics, one or more embodiments include grouping at least a portion of such backup policies by their backup frequency and/or their retention duration. A goal of an example embodiment can include refining the clusters to ensure that policies within the same group have identical frequencies and retentions, enabling efficient consolidation in one or more subsequent phases.

Within each cluster, such an embodiment can include identifying sub-groups wherein policies have the same backup frequency and retention duration parameters, wherein such identifications can include implementing one or more adjustments to cluster boundaries and/or sub-clustering within one or more larger clusters. More particularly, at least one embodiment can include representing each policy by a vector Pᵢ=(fᵢ,rᵢ), wherein fᵢ represents the backup frequency and rᵢ represents the retention duration of policy i.

Additionally, with respect to sub-group formation criteria, two policies, Pᵢ and Pⱼ, can be deemed as belonging to the same sub-group if and only if fᵢ=fⱼ and rᵢ=rⱼ. Also, an algorithm for sub-group formation can include the following steps: for each cluster identified in an analysis phase, extract all policies within the cluster; for each policy in the cluster, identify its backup frequency and retention duration; and group policies with identical backup frequencies and retention durations by utilizing a hashing and/or grouping algorithm.

FIG. 3 is a flow diagram of a process for dynamically enhancing data backup operations using artificial intelligence techniques in an illustrative embodiment. It is to be understood that this particular process is only an example, and additional or alternative processes can be carried out in other embodiments.

In this embodiment, the process includes steps 300 through 306. These steps are assumed to be performed by the automated data backup enhancement system 105 utilizing elements 112, 114, 116, 118, 120, 122 and/or 124.

Step 300 includes generating one or more modified sets of one or more time windows for performing at least one data backup operation for a given system by processing, using one or more artificial intelligence techniques, data pertaining to one or more existing sets of one or more time windows for performing the at least one data backup operation for the given system. In at least one embodiment, generating one or more modified sets of one or more time windows includes processing, using at least one generative model, the data pertaining to the one or more existing sets of one or more time windows for performing the at least one data backup operation for the given system. In such an embodiment, the at least one generative model can include at least one generative diffusion model.

Additionally or alternatively, generating one or more modified sets of one or more time windows can include generating one or more expanded versions of the one or more existing sets of one or more time windows by simulating, using the one or more artificial intelligence techniques, one or more scenarios wherein at least a portion of the one or more existing sets of one or more time windows are expanded. In such an embodiment, generating one or more modified sets of one or more time windows can include contracting at least a portion of the one or more expanded versions of the one or more existing sets of one or more time windows using the one or more artificial intelligence techniques in accordance with one or more data backup operation scheduling constraints.

Step 302 includes predicting future system load information associated with the given system by processing one or more system-related metrics using at least one analytics model. In one or more embodiments, predicting future system load information associated with the given system comprises processing, using the at least one analytics model, one or more system-related metrics pertaining to one or more of CPU usage, memory consumption, network bandwidth, and disk I/O. Additionally or alternatively, predicting future system load information associated with the given system can include processing the one or more system-related metrics using one or more time series forecasting techniques comprising one or more of at least ARIMA model and at least one LSTM network model.

Step 304 includes dynamically adjusting at least a portion of the one or more modified sets of the one or more time windows by processing the predicted future system load information and the one or more modified sets of the one or more time windows. In at least one embodiment, dynamically adjusting at least a portion of the one or more modified sets of the one or more time windows includes aligning the at least a portion of the one or more modified sets of the one or more time windows with one or more periods of predicted future system load information associated with a system load level below a given threshold.

Step 306 includes performing one or more automated actions based at least in part on the dynamic adjusting of the at least a portion of the one or more modified sets of the one or more time windows. In one or more embodiments, performing one or more automated actions includes executing the at least one data backup operation for the given system in accordance with the one or more dynamically adjusted sets of the one or more time windows. Additionally or alternatively, performing one or more automated actions can include automatically training at least a portion of the one or more artificial intelligence techniques using feedback related to the dynamic adjusting of the at least a portion of the one or more modified sets of the one or more time windows.

In at least one embodiment, the techniques depicted in FIG. 3 can include categorizing, into groups related to backup frequency and backup retention duration, portions of the data pertaining to the one or more existing sets of one or more time windows. Such an embodiment can also include merging backup policies, within the data pertaining to the one or more existing sets of one or more time windows, having at least one of one or more overlapping time windows and one or more adjacent time windows, by analyzing at least a portion of the categorized portions of the data.

Accordingly, the particular processing operations and other functionality described in conjunction with the flow diagram of FIG. 3 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to dynamically enhance data backup operations using generative models. These and other embodiments can effectively overcome problems associated with fixed and/or static backup windows which do not account for variability in system usage.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

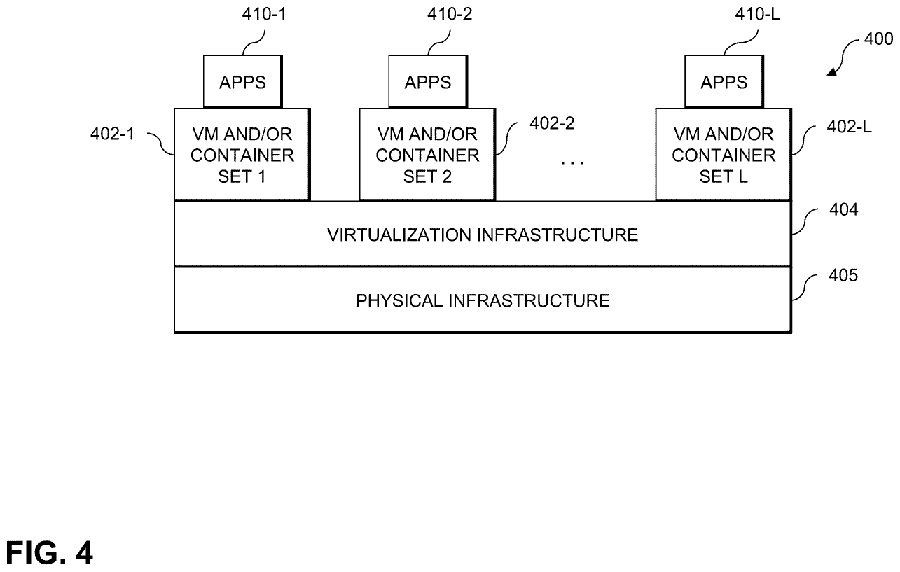

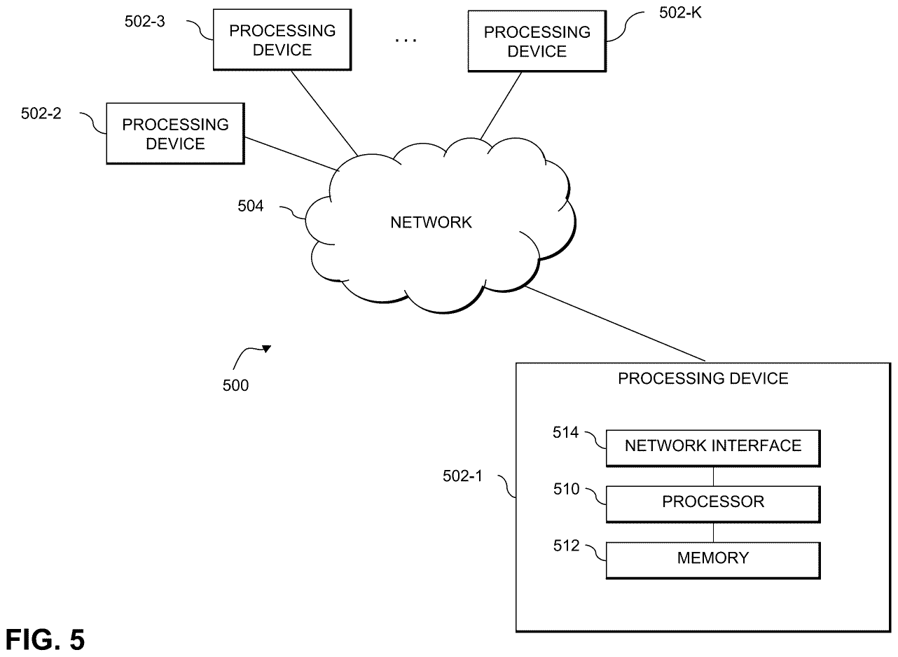

Illustrative embodiments of processing platforms will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that are utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 comprise respective VMs, respective sets of one or more containers, or respective sets of one or more containers running in VMs. In some implementations of the FIG. 4 embodiment, the VMs/container sets 402 comprise respective VMs implemented using virtualization infrastructure 404 that comprises at least one hypervisor.

A hypervisor platform may be used to implement a hypervisor within the virtualization infrastructure 404, wherein the hypervisor platform has an associated virtual infrastructure management system. The underlying physical machines comprise one or more information processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 502-1 in the processing platform 500 comprises a processor 510 coupled to a memory 512.

The processor 510 comprises a microprocessor, a CPU, a GPU, a TPU, a microcontroller, an ASIC, a FPGA or other type of processing circuitry, as well as portions or combinations of such circuitry elements.

The memory 512 comprises RAM, ROM or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
generating one or more modified sets of one or more time windows for performing at least one data backup operation for a given system by processing, using one or more artificial intelligence techniques, data pertaining to one or more existing sets of one or more time windows for performing the at least one data backup operation for the given system;
predicting future system load information associated with the given system by processing one or more system-related metrics using at least one analytics model;
dynamically adjusting at least a portion of the one or more modified sets of the one or more time windows by processing the predicted future system load information and the one or more modified sets of the one or more time windows; and
performing one or more automated actions based at least in part on the dynamic adjusting of the at least a portion of the one or more modified sets of the one or more time windows;
wherein the method is performed by at least one processing device comprising a processor coupled to a memory.

2. The computer-implemented method of claim 1, wherein generating one or more modified sets of one or more time windows comprises processing, using at least one generative model, the data pertaining to the one or more existing sets of one or more time windows for performing the at least one data backup operation for the given system.

3. The computer-implemented method of claim 2, wherein processing the data pertaining to the one or more existing sets of one or more time windows for performing the at least one data backup operation for the given system using at least one generative model comprises processing, using at least one generative diffusion model, the data pertaining to the one or more existing sets of one or more time windows for performing the at least one data backup operation for the given system.

4. The computer-implemented method of claim 1, wherein performing one or more automated actions comprises executing the at least one data backup operation for the given system in accordance with the one or more dynamically adjusted sets of the one or more time windows.

5. The computer-implemented method of claim 1, wherein dynamically adjusting at least a portion of the one or more modified sets of the one or more time windows comprises aligning the at least a portion of the one or more modified sets of the one or more time windows with one or more periods of predicted future system load information associated with a system load level below a given threshold.

6. The computer-implemented method of claim 1, wherein generating one or more modified sets of one or more time windows comprises generating one or more expanded versions of the one or more existing sets of one or more time windows by simulating, using the one or more artificial intelligence techniques, one or more scenarios wherein at least a portion of the one or more existing sets of one or more time windows are expanded.

7. The computer-implemented method of claim 6, wherein generating one or more modified sets of one or more time windows comprises contracting at least a portion of the one or more expanded versions of the one or more existing sets of one or more time windows using the one or more artificial intelligence techniques in accordance with one or more data backup operation scheduling constraints.

8. The computer-implemented method of claim 1, wherein predicting future system load information associated with the given system comprises processing, using the at least one analytics model, one or more system-related metrics pertaining to one or more of central processing unit (CPU) usage, memory consumption, network bandwidth, and disk input-output.

9. The computer-implemented method of claim 1, wherein predicting future system load information associated with the given system comprises processing the one or more system-related metrics using one or more time series forecasting techniques comprising one or more of at least one autoregressive integrated moving average (ARIMA) model and at least one long short-term memory (LSTM) network model.

10. The computer-implemented method of claim 1, wherein performing one or more automated actions comprises automatically training at least a portion of the one or more artificial intelligence techniques using feedback related to the dynamic adjusting of the at least a portion of the one or more modified sets of the one or more time windows.

11. The computer-implemented method of claim 1, further comprising:
categorizing, into groups related to backup frequency and backup retention duration, portions of the data pertaining to the one or more existing sets of one or more time windows.

12. The computer-implemented method of claim 11, further comprising:
merging backup policies, within the data pertaining to the one or more existing sets of one or more time windows, having at least one of one or more overlapping time windows and one or more adjacent time windows, by analyzing at least a portion of the categorized portions of the data.

13. A non-transitory processor-readable storage medium having stored therein program code of one or more software programs, wherein the program code when executed by at least one processing device causes the at least one processing device:
to generate one or more modified sets of one or more time windows for performing at least one data backup operation for a given system by processing, using one or more artificial intelligence techniques, data pertaining to one or more existing sets of one or more time windows for performing the at least one data backup operation for the given system;
to predict future system load information associated with the given system by processing one or more system-related metrics using at least one analytics model;
to dynamically adjust at least a portion of the one or more modified sets of the one or more time windows by processing the predicted future system load information and the one or more modified sets of the one or more time windows; and
to perform one or more automated actions based at least in part on the dynamic adjusting of the at least a portion of the one or more modified sets of the one or more time windows.

14. The non-transitory processor-readable storage medium of claim 13, wherein generating one or more modified sets of one or more time windows comprises processing, using at least one generative model, the data pertaining to the one or more existing sets of one or more time windows for performing the at least one data backup operation for the given system.

15. The non-transitory processor-readable storage medium of claim 13, wherein performing one or more automated actions comprises executing the at least one data backup operation for the given system in accordance with the one or more dynamically adjusted sets of the one or more time windows.

16. The non-transitory processor-readable storage medium of claim 13, wherein dynamically adjusting at least a portion of the one or more modified sets of the one or more time windows comprises aligning the at least a portion of the one or more modified sets of the one or more time windows with one or more periods of predicted future system load information associated with a system load level below a given threshold.

17. An apparatus comprising:
at least one processing device comprising a processor coupled to a memory;
the at least one processing device being configured:
to generate one or more modified sets of one or more time windows for performing at least one data backup operation for a given system by processing, using one or more artificial intelligence techniques, data pertaining to one or more existing sets of one or more time windows for performing the at least one data backup operation for the given system;
to predict future system load information associated with the given system by processing one or more system-related metrics using at least one analytics model;
to dynamically adjust at least a portion of the one or more modified sets of the one or more time windows by processing the predicted future system load information and the one or more modified sets of the one or more time windows; and
to perform one or more automated actions based at least in part on the dynamic adjusting of the at least a portion of the one or more modified sets of the one or more time windows.

18. The apparatus of claim 17, wherein generating one or more modified sets of one or more time windows comprises processing, using at least one generative model, the data pertaining to the one or more existing sets of one or more time windows for performing the at least one data backup operation for the given system.

19. The apparatus of claim 17, wherein performing one or more automated actions comprises executing the at least one data backup operation for the given system in accordance with the one or more dynamically adjusted sets of the one or more time windows.

20. The apparatus of claim 17, wherein dynamically adjusting at least a portion of the one or more modified sets of the one or more time windows comprises aligning the at least a portion of the one or more modified sets of the one or more time windows with one or more periods of predicted future system load information associated with a system load level below a given threshold.
